(19) United States
(12) Patent Application Publication
(10) Pub. No.: US 2023/0242321 A1
(43) Pub. Date: Aug. 3, 2023

(54) IN-WHEEL BAG SYSTEM

(71) Applicant: Gary Andrew Myers, Chandler, AZ (US)

(72) Inventor: Gary Andrew Myers, Chandler, AZ (US)

(21) Appl. No.: 18/161,179

(22) Filed: Jan. 30, 2023

Related U.S. Application Data
(60) Provisional application No. 63/304,356, filed on Jan. 28, 2022.

(51) Int. Cl. B65D 81/107; B25H 5/00; B25H 3/00

(52) U.S. Cl. CPC B65D 81/1075; B25H 5/00; B25H 3/006

(57) ABSTRACT

An in-wheel bag system is provided. The system may include a bag with a cover moveable between and open and closed positions and a protective inner member removably received within the bag. The protective inner member has a body portion that includes a plurality of recesses formed within the body portion. Each of the plurality of recesses are sized and shaped to receive tools and a belt. One of the recesses is an impact wrench recess to receive an impact wrench. Two slots are formed in the body portion and extending from a bottom side of the body portion through a bottom surface of the impact wrench recess. A securing member extends through the slots to retain the impact wrench within the impact wrench recess in a fixed position relative to the body portion. This prevents accidental depressing off a trigger of the impact wrench and draining the battery.

### CROSS REFERENCE TO RELATED APPLICATION

### Related Application

This application claims priority to U.S. Provisional Patent Application Ser. No. 63/304,356, filed Jan. 28, 2022, the disclosure of which is hereby incorporated entirely herein by reference.

### BACKGROUND OF THE INVENTION

### Technical Field

This invention relates generally to tool bags and particularly to an in-wheel bag system.

### State of the Art

Conventional tool bags are commonly used by tradesmen, hobbyists, emergency medical and fire technicians, and others, to organize, carry, and protect the owner's tools. They may comprise any of a variety of interior and/or exterior pockets and/or storage compartments. They may be made of flexible materials, such as rugged fabric, polyester, or leather, for example, having any of a variety of handles and/or shoulder straps, making them light-weight and easily portable.

In the offroad industry, particularly with UTVs, trucks and so forth, there is a need to carry various tools for various specific purposes. Some common tools include an impact gun with sockets in order to replace wheels and tires that may be damaged during a ride, belts and tools to change belts, because belts can often fail. There are several bag systems that have been developed for carrying such tools. Bags, such as in-wheel bags have been developed to store within the spare tire until use is required, these bags however are lacking in their ability to protect the tools and belts.

Accordingly, what is needed is an improved in-wheel bag system for organizing, carrying, and protecting tools.

### SUMMARY OF THE INVENTION

The present invention relates to an in-wheel bag system that includes a protective inner member and an outer bag, wherein the protective inner member is held within the bag and the bag is secured within a spare tire of an offroad vehicle.

An embodiment includes an in-wheel bag system may comprise a bag with a cover moveable between and open and closed position; and a protective inner member that is removably received within the bag, the protective inner member comprising a body portion, wherein a body portion comprises: a plurality of recesses formed within the body portion, wherein the plurality of recesses include an impact wrench recess to receive an impact wrench; two slots formed in the body portion and extending from a bottom side of the body portion through a bottom surface of the impact wrench recess; and a securing member extending through the slots to retain the impact wrench within the impact wrench recess in a fixed position relative to the body portion wherein a trigger of the impact wrench is free of contact with the body portion.

An embodiment includes a method of using an in-wheel bag system, the method comprising: providing a bag with a cover moveable between and open and closed position, and a protective inner member that is removably received within the bag, the protective inner member comprising a body portion, wherein a body portion comprises: a plurality of recesses formed within the body portion, wherein the plurality of recesses include an impact wrench recess to receive an impact wrench; two slots formed in the body portion and extending from a bottom side of the body portion through a bottom surface of the impact wrench recess; and a securing member extending through the slots; retaining the impact wrench within the impact wrench recess in a fixed position relative to the body portion; and inhibiting depression of the trigger of the impact wrench in response to retaining the impact wrench within the impact wrench recess.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in conjunction with the Figures, wherein like reference numbers refer to similar items throughout the Figures, and:

FIG. 1 is a top view of an in-wheel bag system, in an open configuration, according to an embodiment;

FIG. 2 is a top view of an in-wheel bag system, in an open configuration, according to an embodiment;

FIG. 3 is a top view of an in-wheel bag system, in an open configuration, according to an embodiment;

FIG. 4 is a top view of an in-wheel bag system, in an open configuration, according to an embodiment;

FIG. 5 is a top view of an in-wheel bag system, in an open configuration, according to an embodiment;

FIG. 6 is a top view of an in-wheel bag system, in an open configuration, according to an embodiment; and

FIG. 7 is a top view of an in-wheel bag system, in an open configuration, according to an embodiment.

### DETAILED DESCRIPTION OF EMBODIMENTS OF THE INVENTION

As discussed above, embodiments of the present invention relate to an in-wheel bag system that includes a protective inner member and an outer bag, wherein the protective inner member is held within the bag and the bag is secured within a spare tire of an offroad vehicle.

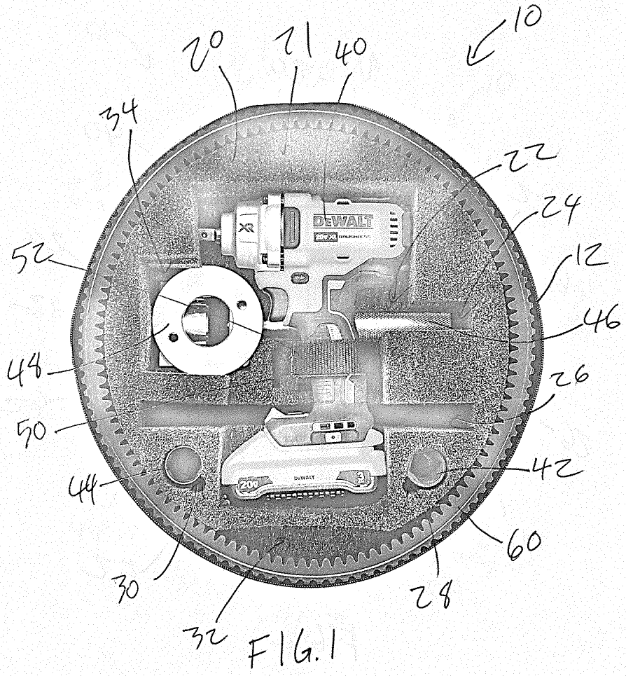

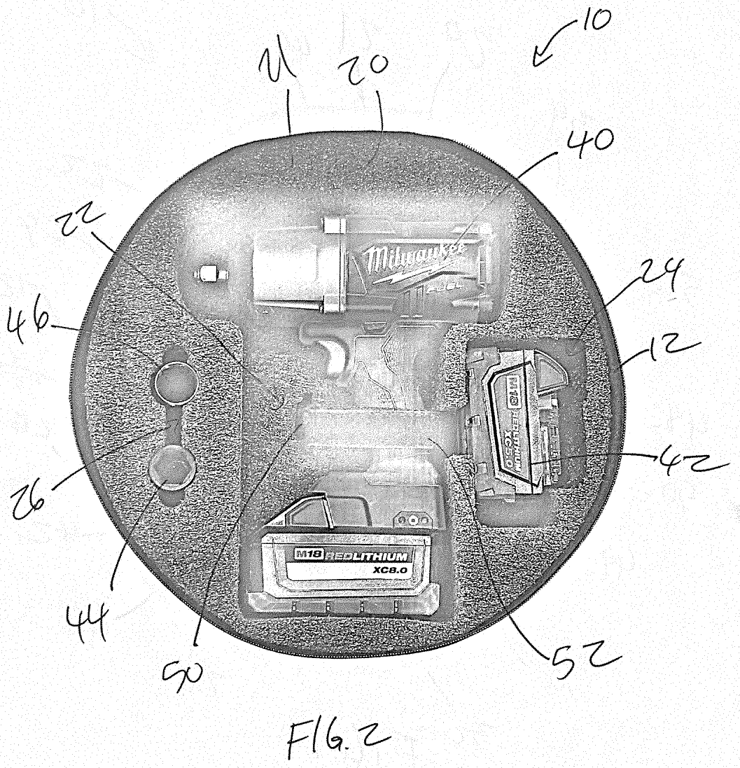

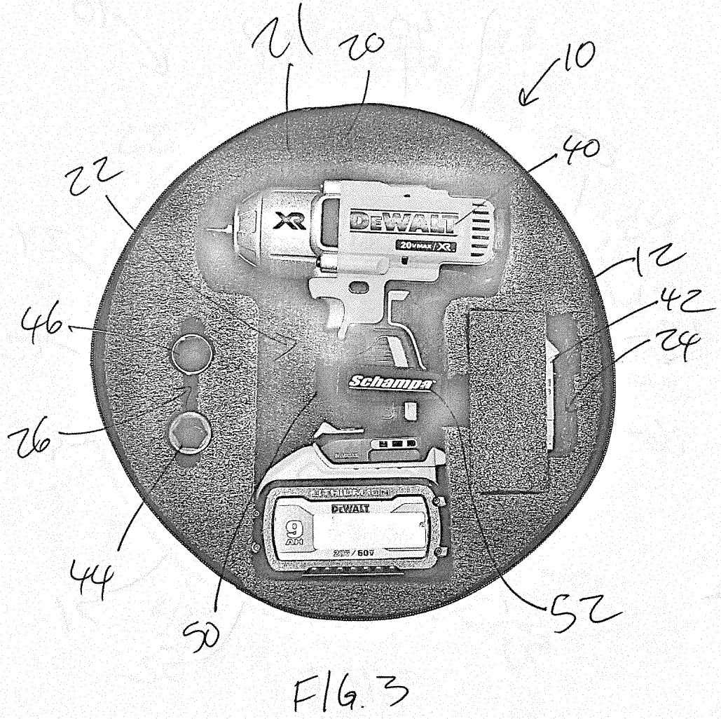

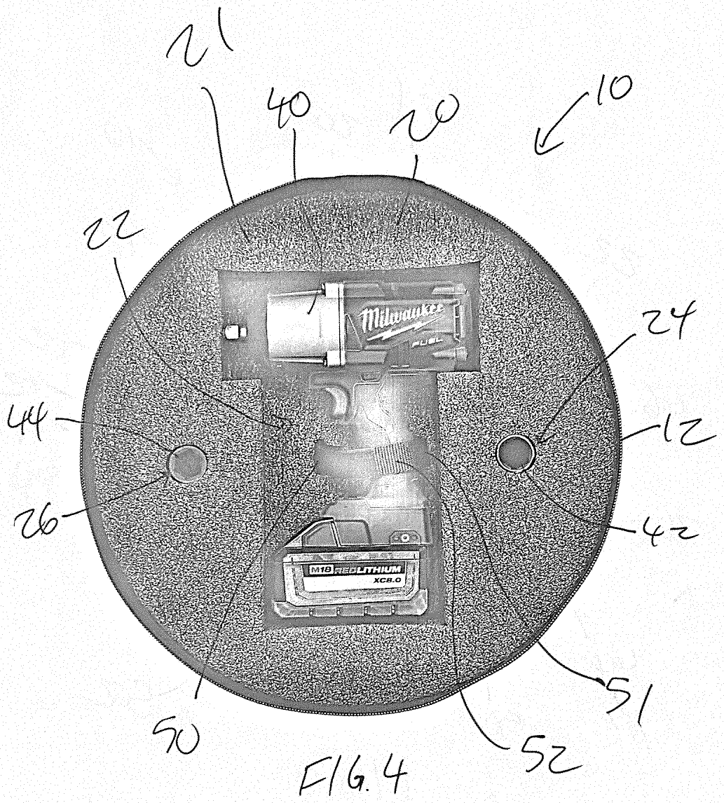

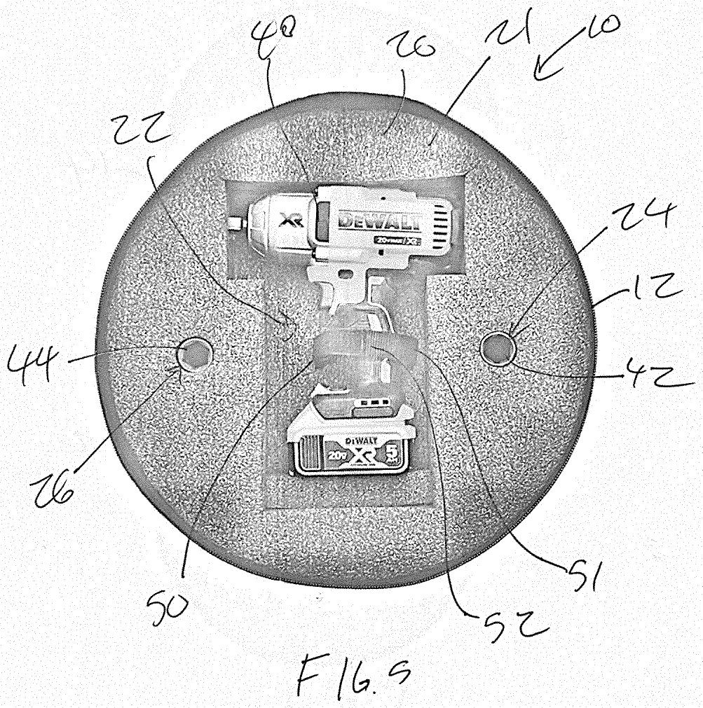

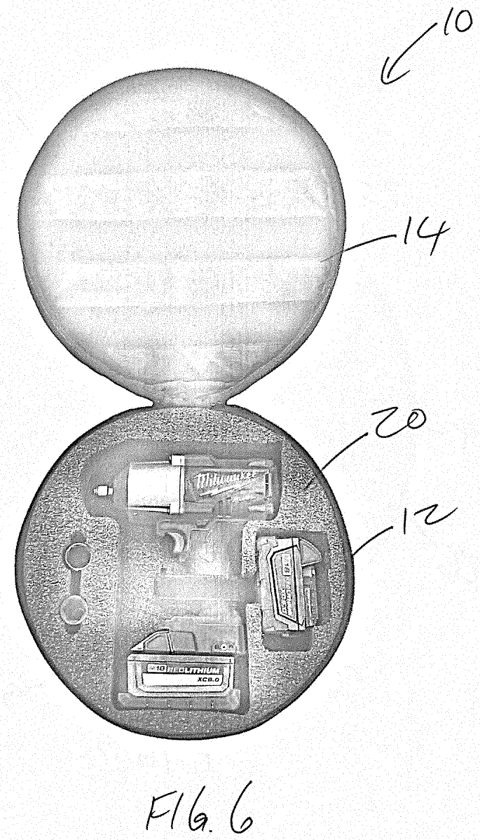

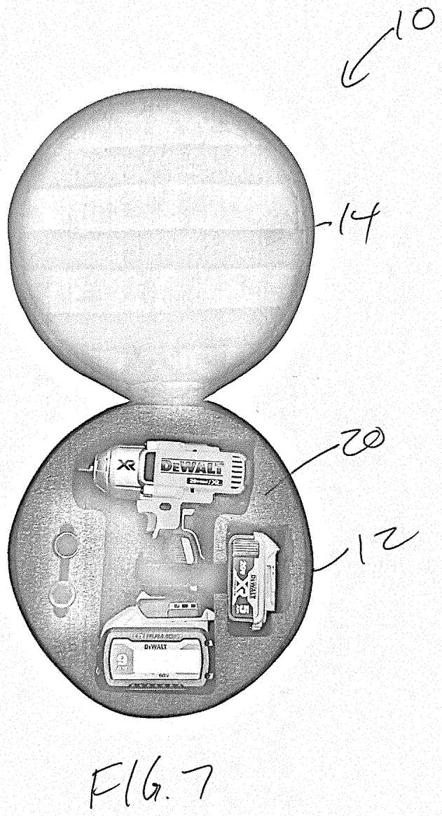

Referring to FIGS. 1-7, embodiments include an in-wheel bag system 10. The system 10 may include a bag 12 with a cover 14 moveable between and open and closed position. The cover 14 may be coupled to the bag 12 with a seam on one end and may be held in a closed position by use of a zipper, as shown in FIGS. 6 and 7. The system 10 may also include a protective inner member 20 that is removably received within the bag as shown in FIGS. 1-7 and the cover 14 may be moved to the closed position to prevent access to the protective inner member 20 or may be moved to the opened position (as shown in FIGS. 6 and 7) and provide access to the protective inner member 20 and the tools held by the protective inner member 20.

Various configurations of the protective inner member 20 are depicted in FIGS. 1-5. The protective inner member 20 may have a body portion 21. In embodiments, the body portion 21 is formed of a foam material that serves to insulate and protect the tools that are to be retained with the protective inner member 20. The body portion comprises a plurality of recesses 22, 24, 26, 28, 30, 32, 34 (for example) formed within the body portion 21. The plurality of recesses sized and shaped to receive tools 40, 42, 44, 46, and 48 and a belt 60, wherein the plurality of recesses 22, 24, 26, 28, 30, 32, 34 include an impact wrench recess 22 to receive an impact wrench 40. The body portion 21 may further include two slots 50 and 51 formed in the body portion 21 and extending from a bottom side of the body portion 21 through a bottom surface of the impact wrench recess 22. A securing member 52 may extend through the slots 50 and 51 to retain the impact wrench 40 within the impact wrench recess 22 in a fixed position relative to the body portion 21. This operates to prevent accidental depressing off a trigger of the impact wrench 40 and draining a battery of the impact wrench 40. The securing member 52 bay be a strap that includes a fastening device, such as a buckle, hook-and-loop fasteners or other coupling devices that may be utilized to extend through slots and retain the impact wrench 40 in a fixed position with respect to the body portion 21 of the protective inner member 20.

Further, in embodiments where the body portion 21 include a recess for receiving the belt 60, the recess may be on an outer circumference of the body portion 21 to form a ledge, wherein on the belt is coupled onto the ledge. The remainder of the recesses and tools are held within the body portion 21 within the circumference of the belt 60.

The system 10 may all be retained within a spare tire of an offroad vehicle. The bag 12 and the protective inner member 20 may be sized and shaped to fit within the spare tire.

An embodiment includes a method of using an in-wheel bag system, the method comprising: providing a bag with a cover moveable between and open and closed position, and a protective inner member that is removably received within the bag, the protective inner member comprising a body portion, wherein a body portion comprises: a plurality of recesses formed within the body portion, wherein the plurality of recesses include an impact wrench recess to receive an impact wrench; two slots formed in the body portion and extending from a bottom side of the body portion through a bottom surface of the impact wrench recess; and a securing member extending through the slots; retaining the impact wrench within the impact wrench recess in a fixed position relative to the body portion; and inhibiting depression of the trigger of the impact wrench in response to retaining the impact wrench within the impact wrench recess.

The components defining any modular tool bag system may be formed of any of many different types of materials or combinations thereof that can readily be formed into shaped objects provided that the components selected are consistent with the intended operation of a modular tool bag system. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as copper, zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any modular tool bag system may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, sewing, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An in-wheel bag system comprising:
a bag with a cover moveable between and open and closed position; and
a protective inner member that is removably received within the bag, the protective inner member comprising a body portion, wherein a body portion comprises:
a plurality of recesses formed within the body portion, wherein the plurality of recesses include an impact wrench recess to receive an impact wrench;
two slots formed in the body portion and extending from a bottom side of the body portion through a bottom surface of the impact wrench recess; and
a securing member extending through the slots to retain the impact wrench within the impact wrench recess in a fixed position relative to the body portion wherein a trigger of the impact wrench is free of contact with the body portion.

2. The system of claim 1, wherein the securing member is a strap.

3. The system of claim 1, wherein the plurality of recesses comprises a belt recess for receiving a belt, the belt recess located on an outer circumference of the body portion to form a ledge, wherein on the belt is coupled onto the ledge.

4. The system of claim 3, wherein the plurality of recesses except the belt recess are located within a circumference of the belt recess.

5. A method of using an in-wheel bag system, the method comprising:
providing a bag with a cover moveable between and open and closed position, and a protective inner member that is removably received within the bag, the protective inner member comprising a body portion, wherein a body portion comprises:
a plurality of recesses formed within the body portion, wherein the plurality of recesses include an impact wrench recess to receive an impact wrench;
two slots formed in the body portion and extending from a bottom side of the body portion through a bottom surface of the impact wrench recess; and
a securing member extending through the slots;
retaining the impact wrench within the impact wrench recess in a fixed position relative to the body portion; and
inhibiting depression of the trigger of the impact wrench in response to retaining the impact wrench within the impact wrench recess.

6. The method of claim 5, wherein the securing member is a strap.

7. The method of claim 5, wherein the plurality of recesses comprises a belt recess for receiving a belt, the belt recess located on an outer circumference of the body portion to form a ledge, wherein on the belt is coupled onto the ledge.

8. The method of claim 7, wherein the plurality of recesses except the belt recess are located within a circumference of the belt recess.

9. The method of claim 5 further comprising retaining the in-wheel bag system within a spare tire of an offroad vehicle.
